(19) United States
(12) Patent Application Publication
(10) Pub. No.: US 2003/0159200 A1
(43) Pub. Date: Aug. 28, 2003

(54) Antimicrobial fabrics through surface modification

(76) Inventor: Don Elrod, College Station, TX (US)

Correspondence Address: STREETS & STEELE, 13831 NORTHWEST FREEWAY, SUITE 355, HOUSTON, TX, 77040, US

(21) Appl. No.: 10/084,829

(22) Filed: Feb. 28, 2002

(51) Int. Cl. A62B 17/00; G21F 3/02; A41D 13/12

(52) U.S. Cl. 2/456

(57) ABSTRACT

A method of graft polymerization in order to covalently bond groups that are antimicrobial or can be made antimicrobial by subsequent chemical modification. These groups are bonded to fabrics, which can be used in a variety of applications without impairing the physical properties of the fabric. Additionally, the treatment may be made renewable by exposing the fabric to specific chemical reagents.

### BACKGROUND OF THE INVENTION

1. Field of the Invention

The present invention relates to antimicrobial polymeric materials, such as fabrics or other surfaces, prepared by chemical modification of the polymeric surfaces and methods of preparing polymeric materials to include antimicrobial properties.

2. Background of the Related Art

The development of fabrics and surfaces possessing antimicrobial properties for use in medicine has been a topic of great interest in recent years. Most of the known antimicrobial fabrics and surfaces are prepared by adding known antimicrobial agents to fabric. Most of these agents are impregnated into or coated onto the fibrous matrix. However, some textiles have covalently linked antimicrobial agents, thereby preventing leaching of the antimicrobial compound from the fabric. For example, synthetically immobilized antimicrobial enzymes, such as lysozyme and chymotrypsin, have been attached to cellulose, rendering bandages or wound covers comprised of these substances antimicrobial. Also, cellulose has been treated with chitosan and citric acid, forming covalent bonds between citric acid and cellulose, as well as between citric acid and the hydroxyl groups of chitosan. Some antimicrobial activity against Staphylococcus aureus has been shown by cotton bonded with both components and with citric acid alone. However, citric acid treatment severely compromises the structural integrity of the cotton and microbes may develop resistance to the effects of chitosan. Furthermore, a heterocyclic N-halamine has been covalently attached to cellulose-based fabrics, imparting biocidal activity. This biocidal activity could also be regenerated after exhaustion by the fabric with a halogenated solution, but the use of chlorinated compounds is contraindicated in many biocidal applications.

Therefore, distinct disadvantages are inherent with current antimicrobial fabrics. Those fabrics possessing antimicrobial agents noncovalently dispersed through the fibers have the disadvantage of the agent leaching from the material. This may pose health concerns when these materials are absorbed by human skin, particularly antimicrobial metal ions such as copper, zinc, and silver, or compounds such as chlorinated phenols and quaternary ammonium salts. Because the materials are not permanently bound to the fabric, they cannot withstand frequent washings, making their effective lifetime rather short. Furthermore, most of the antimicrobial compounds used in these finishing processes have specific mechanisms of antimicrobial action, which can spur the development of resistant microorganisms. These antimicrobial agents include metal salts, quaternary ammonium salts, chlorhexidine, triclosan, chitosan, enzymes such as lysozyme, and many others. Except for the n-halamine fabric, none of the fabric materials containing these agents can be regenerated. Therefore, after the antimicrobial properties of these fabrics have been exhausted, they can no longer be used.

Therefore, a need exists for a method for covalently bonding antimicrobial functional groups to surfaces to provide potent antimicrobial protection, without damaging the physical structure of the material or significantly affecting the physical properties of the material. It would be desirable if the means by which the antimicrobial protection was achieved was nonspecific, so that microbial resistance could not develop. It would be also desirable if the protection was renewable, involving a simple step to allow for continuous antimicrobial protection.

### SUMMARY OF THE INVENTION

The invention provides a method of making antimicrobial fabrics comprising the steps of treating a fabric with any method of graft polymerization that would create a free radical species on the surface of the fabric, such as the use of ozone to form peroxide groups on the fabric, subsequently decomposing the peroxide groups with an iron catalyst to form oxygen radicals, then grafting a polymerizable monomer to the oxygen radicals on the fabric surface. In a preferred embodiment, the monomer is a carboxylic acid, such as acrylic acid. The peracid is formed by, and may be regenerated by, exposing the carboxylic acid of the fabric to mineral acid and hydrogen peroxide. Preferably, the fabric is selected from the group consisting of cotton, linen, gauze, polyester, nylon, acrylic and blends thereof. Optionally, the monomer has a nonpolymerizable functional group selected from carboxyl, amino, hydroxyl, sulfhydryl, amido, and mixtures thereof. In a preferred embodiment, there is provided a polymerizable co-monomer along with the monomer to form a copolymer. The monomers forming the copolymers may be selected from the group consisting of quaternary ammonium salts, quaternary phosphonium salts, peracids, biguanides, iodophors, n-halamines and combinations thereof. The copolymers may also contain metal salts. Preferably, the resultant fabric has sufficient antimicrobial activity to kill bacteria selected from the group consisting of Staphylococcus aureus, E. coli and Pseudomonas aeruginosa.

The invention further provides an antimicrobial fabric produced in accordance with the foregoing method. Preferably, the fabric retains sufficient resilience, pliability and strength to be used in any of the various applications in which fabric is typically used. Optionally, this fabric is formed into garments selected from the group consisting of masks, scrubs, lab coats, and caps. Optionally, the fabric is formed into surgical drapes or privacy drapes. The fabric may also be formed into bed sheets and bedding. In a preferred embodiment, the fabric is formed into towelettes and hygiene wipes. The fabric may also be formed into dressings or bandages.

### DETAILED DESCRIPTION OF THE INVENTION

The present invention provides an antimicrobial fabric and a method of making the fabric. Particularly, the method involves employing the technique of ozone-induced grafting to form peroxide groups on fabric, decomposing these peroxide groups with an iron catalyst to form oxygen radicals, and then grafting a polymerizable monomer on the surface of the fabric. The monomers have either a functional group that has antimicrobial activity, or a functional group that can be converted to a form that has antimicrobial activity. The fabric produced in accordance with this method has disinfectant properties and may be formed into garments or into items such as surgical drapes, bedding, and towelettes.

The fabric used in the method of the present invention is selected from the group consisting of cotton, linen, gauze, polyester, nylon, acrylic and blends thereof. In a preferred embodiment, the fabric is cotton. This fabric may be formed into garments such as masks, scrubs, lab coats, and caps. It may further be formed into items such as surgical drapes, bed sheets, bedding, privacy drapes, towelettes, hygiene wipes, dressings and bandages. Treatment of the fabric with the method of the present invention does not disrupt the physical properties of the fabric, as measured by such parameters as interfiber adhesion, tensile strength and tear or abrasion resistance.

The treatment of fabric with ozone results in the formation of peroxides on the surface of the fabric. Subsequent decomposition of the peroxides with an iron catalyst provides oxygen radicals, which can be used to graft a polymerizable monomer onto the cotton surface. However, any method for creating a free radical species on the surface of the fabric on which graft polymerization from the surface of the fabric could take place may be used. These methods include, without limitation, ozone-induced grafting, gamma irradiation, UV-assisted, flame-initiated and plasma-induced graft polymerization techniques.

Monomers suitable for use in accordance with the present invention include, without limitation, quaternary ammonium salts, quaternary phosphonium salts, peracids, biguanides, iodophors, n-halamines and combinations thereof. The technique of ozone-induced grafting may be used to attach other antimicrobial or antimicrobial precursor molecules including, but not limited to, metal salts such as silver, copper, zinc, and the like. In a preferred embodiment, the polymerizable monomer is a carboxylic acid, particularly acrylic acid. It will be beneficial for some applications to use a mixture of monomers to achieve a synergistic effect.

Where the monomer is a carboxylic acid, the carboxyl functional group can then be reacted with a mineral acid and hydrogen peroxide to form a peracid functionality on the surface of the fabric. Because the peracid group is a nonspecific oxidizer, microorganisms are eradicated without the likelihood of significant resistance developing and chemical agents are decontaminated on contact with the modified fabric surface. The decomposition product of the modified textile is oxygen, with the grafted monomer returning to its carboxylic acid form.

The antimicrobial fabric can be used to form protective clothing that will eradicate microorganisms on the skin, hair, and nostrils of the surgeons and surgical staff. It could also be used to form fabrics in contact with the patient that would shield the patient from their own flora. These garments could also be used during the postoperative or non-surgical stay to break the cycle of contamination and infection that routinely occurs between the patient, hospital personnel, and subsequent patients. In addition, these surface-modified fabrics could be used in chemical-protective clothing for agricultural workers to reduce skin exposure to pesticides as well as protecting military personnel from biological and chemical weapons. These fabrics could also have broad applications as household disinfection and hygiene wipes and could be incorporated into many consumer product applications.

The peracid functional groups are permanently immobilized to the fabric providing potent microbial and chemical protection. These groups nonspecifically oxidize pathogenic microbes, thereby reducing the chances of microbial resistance. Such a fabric could also be used for the eradication or protection from gram-positive and gram-negative bacteria, mold, fungi and viruses. Additionally, the peracids do not leach harmful byproducts from the fabric. The process of ozone-induced grafting is simple, inexpensive, and since only the surface is modified, the bulk of the fabric retains its original, desirable properties. This is especially important with substrates such as cotton, which are used for garments. Importantly, after exhaustion of the fabric's antimicrobial/detoxifying properties, regeneration can be accomplished by treating the fabric with mineral acid and hydrogen peroxide. The resulting regenerated fabric will perform as efficiently as the original antimicrobial fabric. Such fabric has a wide variety of end uses and can serve many sectors including medicine, agriculture, military, and consumer products.

The level of antimicrobial activity imparted to the fabric may be controlled by changing the extent of the ozone induced grafting and the type and concentration of monomers provided for polymerization. Where the monomers are carboxylic acids, the antimicrobial activity may be further affected by the percentage of carboxyl groups converted to peracid groups. One or more of these variables may be controlled to set the level of antimicrobial activity. Preferably, these variables are controlled in a manner that balances the need for high antimicrobial activity, such as disinfecting or sterilizing activity, with the need to preserve the physical properties of the fabric, such as the wearability and durability.

### EXAMPLE 1

### Synthesis of Antimicrobial Peracid Fabric by Ozone-Induced Grafting

Three-1 and ½ inch square pieces of 100% cotton fabric were cut and immersed in deionized water overnight. 14 g of deionized water and 6 g of acrylic acid (Aldrich Chemical Company, Milwaukee, Wis.) were transferred to a 500 mL round bottom flask. 20 mg of Fe (II) ammonium sulfate hexahydrate salt (Fluka Corporation, Milwaukee, Wis.) were dissolved in the reaction mixture with stirring. The resulting solution was degassed with dry nitrogen gas for 4 hours prior to reaction.

The pieces of cotton fabric were removed from the water, dabbed dry, and placed in a glass/Teflon chamber fitted with a gas inlet and outlet. The chamber was then connected to an electrochemical ozone generator and ozone gas (11 wt. % and 750 mL/min) was allowed to flow through the chamber and out to an ozone destruct apparatus. The ozone pressure in the chamber was kept between 12 and 15 psi. The cotton pieces were ozonated for 1 hour.

The pieces of fabric were then removed from the ozone chamber and transferred to the degassed reaction flask. The flask was then heated to 50-60° C. and slowly stirred for 6-7 hours. The surface grafted fabrics were then removed, wiped with a clean cloth to remove excess polymer and shaken in 500 mL of deionized water overnight to remove any residual acrylic acid monomer or polymer. Then the fabric pieces were washed with 200 mL of methanol on a shaker for several hours. The pieces were dabbed dry with a clean wipe and placed in a dessicator and dried under a vacuum pump overnight. XPS spectra of grafted and non-grafted cotton fabric were obtained. The XPS spectrum for the grafted cotton showed an extra peak corresponding to the carbonyl carbon of the grafted acrylic acid group, thereby confirming the success of the grafting procedure.

The pieces of cotton fabric containing surface grafted acrylic acid groups were chemically converted to their peracid analogs by suspending the three pieces of fabric in 32 mL of 25% sulfuric acid in a large test tube, then slowly adding 12.8 mL of 50% hydrogen peroxide to the acid. The mixture was shaken overnight at room temperature. The fabric pieces were then removed, and washed of residual acid and hydrogen peroxide with deionized water. Washing was continued until the washes contained less than 1 ppm residual hydrogen peroxide as determined with a commercially available hydrogen peroxide kit (Model HP-40, Lamotte Company, Chestertown, Md.). The pieces were then dabbed dry with a clean cloth and placed in a desiccator under vacuum overnight to remove any remaining hydrogen peroxide residual. The reaction scheme associated with the attachment of a peracid to cotton fabric is as follows:

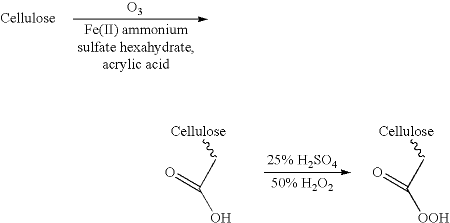

### EXAMPLE 2

### Zone of Inhibition Testing of Peracid Grafted Fabric

The following procedure is analogous to the Kirby-Bauer Disk-Diffusion Test, known to those of ordinary skill in the art. A suspension of the microbial challenge organism was prepared and plated prior to the experiment in order to quantitate the concentration of each microorganism (˜1.0×10⁸ CFU/mL). A sterile cotton swab was dipped in the microbial suspension, the excess was removed, and the swab was streaked over the surface of Mueller-Hinton agar while rotating the agar plate 90° at least three times. The plate was allowed to dry. Both control and test sample plates were prepared containing a single microorganism of choice. Mueller-Hinton agar was used to prepare plates containing Staphylococcus aureus, Escherichia coli, and Pseudomonas aeruginosa. Samples of a control fabric and a test fabric prepared according to Example 1 were obtained by aseptically cutting out 6 mm circles of the fabrics with a sterile biopsy punch. The fabric samples were then aseptically placed on their respective plates using sterilized tweezers. All plates were then incubated at 37° C. for 24 hours. Zones of inhibition were then measured in mm.

The antimicrobial cotton did leach a sufficient amount of an antimicrobial species to create zones of inhibition on plates containing gram-positive and gram-negative bacteria. The zones of inhibition varied depending on the sample from 8-12 mm. In most cases, a small zone of inhibition, sometimes barely wider that the cloth circle itself, was observed probably due to the stable nature of the antimicrobial. The antimicrobial activity comes from the homolytic oxygen-oxygen bond cleavage of the peracid, which releases hydroxyl radicals into the agar surface. These observations are in sharp contrast to fabrics containing antimicrobial additives that are simply blended into the fiber during the manufacturing process. In these cases, the zones of inhibition are quite large since there is no bonding between the antimicrobial and the fabric. Thus, the antimicrobial diffuses out quite readily. This is also observed when sterile disks are simply dipped into antibiotic solutions, which after being placed on the agar surface rapidly diffuse out creating large zones of inhibition. Because the present antimicrobial fabric has an antimicrobial agent that is permanently attached to the cloth surface, it should sustain its activity much longer than cloth that is simply impregnated with an antimicrobial agent.

### EXAMPLE 3

### Quantitative Efficacy Testing

This method was adopted from the American Association of Textile Chemists and Colorists Test Method 100, Assessment of Antibacterial Finishes on Textile Materials. Cotton fabric containing grafted peracid functional groups and control pieces of non-grafted cotton were challenged with suspensions of Staphylococcus aureus (˜10⁷ CFU/mL). A one and ½ inch piece of cotton fabric was placed in a sterile Petri dish and 500 μL of the challenge organism was added to the surface. At a specific contact time, the cotton fabric was aseptically transferred to a sterile test tube containing 4.5 mL of 10% sodium thiosulfate/10% bovine serum albumin (to neutralize any residual disinfectant) and the test tube was sonicated for 15 minutes. Aliquots from the test tube were taken, serially diluted, and plated onto nutrient agar, allowed to dry, and incubated at 37° C. for 24 hours. Plate counts were then performed in order to calculate a log reduction. Control samples and grafted samples were treated exactly the same. One piece of cotton (grafted in accordance with Example 1 or non-grafted control) was used for each given microbial challenge and contact time.

As shown below in Table 1, a total of 18 pieces of peracid-grafted cotton, (in 6 separate experiments) were tested for antimicrobial efficacy against Staphylococcus aureus with a contact time of 30 minutes. The grafted cotton fabric displayed an average 4-log reduction.

TABLE 1
Quantitative Antimicrobial Efficacy of Peracid
Cotton Against Staphylococcus aureus

| | | Number of | Average Log |
|---|---|---|---|
| Microorganism | Contact Time | Samples | Reduction |
| Staphylococcus | 30 min | 6 sets of 3 | 4.0 |
| aureus | | cotton pieces* | |

*Each set contained one piece of control (non-grafted) cotton in addition to the 3 grafted pieces of peracid-grafted cotton fabric.

It will be understood that certain combinations and sub-combinations of the invention are of utility and may be employed without reference to other features in sub-combinations. This is contemplated by and is within the scope of the present invention. As many possible embodiments may be made of this invention without departing from the spirit and scope thereof, it is to be understood that all matters hereinabove set forth or shown in the accompanying drawings are to be interpreted as illustrative and not in a limiting sense.

What is claimed is:

1. A method of making antimicrobial fabrics comprising the steps of:
creating a free radical species on a surface of the fabric; and
reacting a polymerizable monomer with the free radical species to initiate graft polymerization of the monomer on the fabric surface, wherein the monomer has a functional group selected from antimicrobial groups, precursors to antimicrobial groups, and combinations thereof.

2. The method of claim 1, wherein the free radical species on the fabric surface is created by means of gamma irradiation polymerization techniques.

3. The method of claim 1, wherein the free radical species on the fabric surface is created by means of UV-assisted polymerization techniques.

4. The method of claim 1, wherein the free radical species on the fabric surface is created by means of flame-initiated polymerization techniques.

5. The method of claim 1, wherein the free radical species on the fabric surface is created by means of plasma-induced polymerization techniques.

6. A method of making antimicrobial fabrics comprising the steps of:
treating a fabric with ozone to form peroxide groups on the fabric;
decomposing the peroxide groups with an iron catalyst to form oxygen radicals; and
grafting a polymerizable monomer to the oxygen radicals on the fabric surface.

7. The method of claim 6, wherein the monomer is carboxylic acid.

8. The method of claim 7, further comprising reacting the grafted monomer with a mineral acid and hydrogen peroxide to form a peracid on the fabric surface.

9. The method of claim 7, wherein the monomer is acrylic acid.

10. The method of claim 6, wherein the monomer is selected from the group consisting of quaternary ammonium salts, quaternary phosphonium salts, peracids, biguanides, iodophors, n-halamines and combinations thereof.

11. The method of claim 6, further comprising:
regenerating the peracid by exposing the fabric to mineral acid and hydrogen peroxide.

12. The method of claim 6, wherein the fabric is selected from the group consisting of cotton, linen, gauze, polyester, nylon, acrylic and blends thereof.

13. The method of claim 6, wherein the monomer has a nonpolymerizable functional group selected from carboxyl, amino, hydroxyl, sulfhydryl, amido, and mixtures thereof.

14. The method of claim 6, further comprising:
providing a polymerizable co-monomer along with the monomer to form a copolymer.

15. The method of claim 14, wherein the copolymers are selected from the group consisting of quaternary ammonium salts, quaternary phosphonium salts, peracids, biguanides, iodophors, n-halamines and combinations thereof.

16. The method of claim 14, wherein the copolymer contains a metal salt.

17. The method of claim 6, characterized in that the antimicrobial fabric has sufficient antimicrobial activity to kill microorganisms selected from the group consisting of gram-negative bacteria, gram-positive bacteria, mold, fungi and viruses.

18. The method of claim 17, wherein the gram-positive bacteria are Staphylococcus aureus.

19. The method of claim 17, wherein the gram-negative bacteria are selected from the group consisting of Escherichia coli and Pseudomonas aeruginosa.

20. The method of claim 6, wherein a disinfecting amount of the polymerizable monomer is grafted onto the fabric.

21. The method of claim 20, wherein the disinfecting amount of the polymerizable monomer grafted onto the fabric is sufficient to detoxify pesticides.

22. The method of claim 20, wherein the disinfecting amount of the polymerizable monomer grafted onto the fabric is sufficient to detoxify chemical and biological weapons.

23. An antimicrobial fabric produced in accordance with the method of claim 6.

24. The fabric of claim 23, wherein the fabric is formed into garments.

25. The garments of claim 24, wherein the garments are selected from the group consisting of masks, scrubs, lab coats, and caps.

26. The fabric of claim 23, wherein the fabric is formed into items selected from the group consisting of surgical drapes, bed sheets, bedding, privacy drapes, towelettes, hygiene wipes, dressings and bandages.

27. The fabric of claim 23, wherein the fabric has disinfectant properties.

28. The method of claim 6, wherein interfiber adhesion of the fabric is not disrupted.

29. The method of claim 6, wherein the method is carried out without substantial loss of fabric strength.

30. The method of claim 6, wherein the fabric retains tensile strength, tear resistance and abrasion resistance.

31. The method of claim 6, wherein the treating step is carried out at a temperature between about 40 and 80° C.

32. The method of claim 6, wherein the step of treating the fabric with ozone is carried out for between 10 minutes and 4 hours.

33. The method of claim 6, wherein the polymerizable monomer is supplied at a concentration of between 1 and 50 percent by weight.
